(19) United States
(12) Patent Application Publication
(10) Pub. No.: US 2017/0036755 A1
(43) Pub. Date: Feb. 9, 2017

(54) Gust Alleviator

(71) Applicant: Albert S. Richardson, Jr., Lexington, MA (US)

(72) Inventor: Albert S. Richardson, Jr., Lexington, MA (US)

(21) Appl. No.: 15/115,064

(22) PCT Filed: Feb. 3, 2015
(86) PCT No.: PCT/US2015/014217

§ 371 Date: Jul. 28, 2016

Related U.S. Application Data
(60) Provisional application No. 61/936,964, filed on Feb. 7, 2014.

(51) Int. Cl. B64C 21/02; B64C 3/58; B64C 13/04; B64C 9/34; B64C 13/16

(52) U.S. Cl. CPC B64C 21/02; B64C 9/34; B64C 13/16; B64C 13/04; B64C 3/58

(57) ABSTRACT

A gust alleviating aircraft wing includes a gust alleviating wing portion on the wing. The wing portion can have a leading edge, a trailing edge, and a downwardly sloping upper surface therebetween. At least one air passageway can extend through the wing portion from the leading edge to a rear or downstream location on the downwardly sloping upper surface of the wing portion. At least one spoiler can be on the upper surface of the wing portion at the rear location for selectively movably covering and uncovering an exit location of the at least one passageway. Opening the at least one passageway is capable of diverting air flow through the at least one passageway and the wing portion for counteracting upward lift caused by a gust of wind.

### RELATED APPLICATION

This application claims the benefit of U.S. Provisional Application No. 61/936,964, filed on Feb. 7, 2014. The entire teachings of the above application are incorporated herein by reference.

### BACKGROUND

Aircraft flying in turbulent air which can include wind gusts, can be subject to sudden or rapid lift, causing a bumpy ride, which can be a discomfort to passengers, or undesirable for cargo.

### SUMMARY OF THE INVENTION

The present invention can provide a gust alleviating aerodynamic member, aircraft wing or system, including a gust alleviating wing portion on the wing. The wing portion can have a leading edge, a trailing edge, and a downwardly sloping upper surface therebetween. At least one air passageway can extend through the wing portion from the leading edge to a rear or downstream location on the downwardly sloping upper surface of the wing portion. The at least one passageway can be a single passageway, or include multiple passageways, with suitable cross sections. At least one spoiler can be on the upper surface of the wing portion at the rear location for selectively movably covering and uncovering an exit location of the at least one passageway. Opening the at least one passageway is capable of diverting air flow through the at least one passageway and the wing portion for counteracting upward lift caused by a gust of wind.

In particular embodiments, the wing portion can be a segment of at least one wing. The gust alleviating wing portion can be a left wing portion on a left wing, and the gust alleviating aircraft wing can further include a gust alleviating right wing portion on a right wing. The at least one spoiler can be pivotably mounted to the upper surface of the wing portion along a hinge upstream from the exit location of the at least one passageway. The at least one spoiler can be at least one of manually and automatically operated. The at least one spoiler can include at least one pivoting plate. The exit location of the at least one passageway can be upstream of a downstream flap of the wing, for directing air exiting the at least one passageway over the downstream flap. At least one valve can be at the inlet location of the at least one passageway, for opening and closing the inlet location of the at least one passageway. The gust of wind can be or include air turbulence.

The present invention can also provide a gust alleviating aerodynamic member or aircraft wing portion. The wing portion can have a leading edge, a trailing edge, and a downwardly sloping upper surface therebetween. At least one air passageway can extend through the wing portion from the leading edge to a rear or downstream location on the downwardly sloping upper surface of the wing portion. The at least one passageway can be a single passageway, or include multiple passageways, with suitable cross sections. At least one spoiler can be on the upper surface of the wing portion at the rear location for selectively movably covering and uncovering an exit location of the at least one passageway. Opening the at least one passageway is capable of diverting air flow through the at least one passageway and the wing portion for counteracting upward lift caused by a gust of wind.

The present invention can also provide a method of compensating for wind gusts with an aerodynamic member, aircraft wing or system. A gust alleviating wing portion can be provided on the wing, and can have a leading edge, a trailing edge, and a downwardly sloping upper surface therebetween. At least one passageway can extend through the wing portion from the leading edge to a rear location on the downwardly sloping upper surface of the wing portion. An exit location of the at least one passageway can be selectively uncovered with at least one selectively movable spoiler on the upper surface of the wing portion at the rear location, thereby opening the at least one passageway and diverting air flow through the at least one passageway and the wing portion for counteracting upward lift caused by the wind gusts.

In particular embodiments, the wing portion can be a segment of at least one wing. The gust alleviating wing portion can be a left wing portion on a left wing, and the gust alleviating aircraft wing can further be provided with a gust alleviating right wing portion on a right wing. The at least one spoiler can be pivotably mounted to the upper surface of the wing portion along a hinge upstream from the exit location of the at least one passageway. The at least one spoiler can be operated by at least one of manual and automatic operation. The at least one spoiler can be provided with at least one pivoting plate. The exit location of the at least one passageway can be positioned upstream of a downstream flap of the wing. Air exiting the at least one passageway can be directed over the downstream flap. The inlet location of the at least one passageway can be opened and closed with at least one valve at the inlet location of the at least one passageway. Compensating for windgusts can include air turbulence. The gust of wind can be or include air turbulence.

### BRIEF DESCRIPTION OF THE DRAWINGS

The foregoing will be apparent from the following more particular description of example embodiments of the invention, as illustrated in the accompanying drawings in which like reference characters refer to the same parts throughout the different views. The drawings are not necessarily to scale, emphasis instead being placed upon illustrating embodiments of the present invention.

FIG. 1 is a schematic plan view of a portion of an embodiment of an aircraft having gust alleviating aircraft wings.

FIG. 2 is a schematic sectional view of an embodiment of a gust alleviating aircraft wing having a gust alleviating wing portion, with a spoiler in a closed position, and FIG. 3 shows the spoiler in an open position.

FIG. 4 is a front schematic view of an upstream or leading edge of an embodiment of a portion of a gust alleviating aircraft wing.

FIG. 5 is a front schematic view of an upstream or leading edge of another embodiment of a portion of a gust alleviating aircraft wing.

### DETAILED DESCRIPTION OF THE INVENTION

A description of example embodiments of the invention follows.

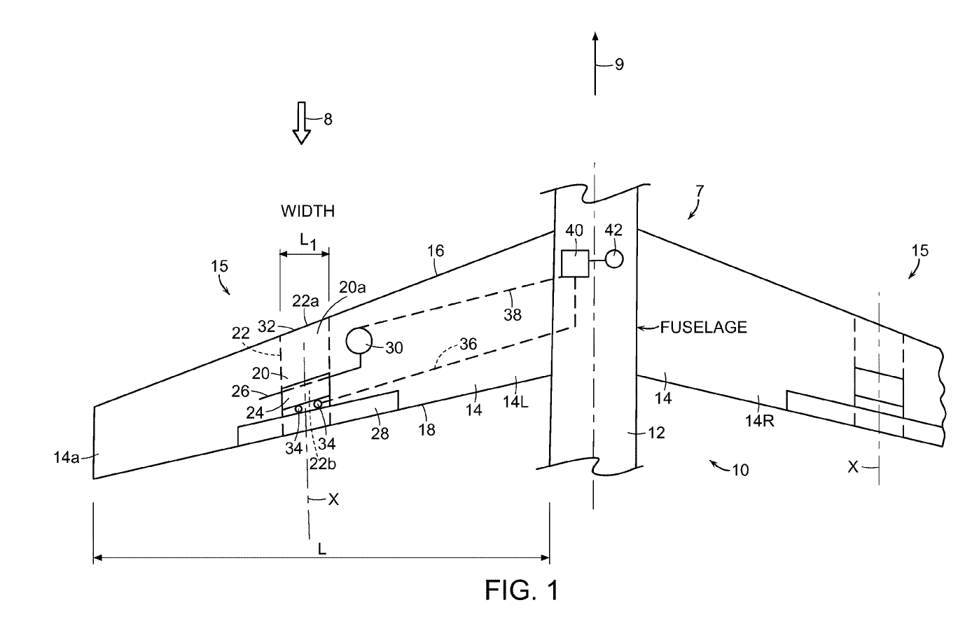

Referring to FIGS. 1-3, an aircraft 10, such as an airplane or jet, can include air turbulence or wind gust compensating or alleviating aerodynamic portions, members or aircraft wings, or system 7, including air turbulence or wind gust compensating or alleviating wing portions, sections or devices 15, such as on left 14L or right 14R wings, which can compensate for air turbulence or wind gusts during flight, including take-off and landing. The gust alleviating wing positions 15 can be positioned on a wing 14 about or around or close to halfway, or partway between the tip 14a of the wing 14 and the fuselage 12, and can have a lateral length L₁ that is a small percentage of the lateral length L of the wing 14. The wing portion 15 can be a segment or section of a wing 14 or can be installed or retrofitted thereon. The length L₁ can only be a few feet, such as 1-5 feet or 2-4 feet, or 3-4 feet, depending upon the situation at hand, and the size of the aircraft 10 or wing 14.

A single wing portion 15 is now discussed. The wing 14 and the wing portion 15 can have an upstream, forward or leading edge, end or surface 16 with a stagnation point, and a downstream, rearward or trailing edge, end or surface 18. A downwardly sloping top or upper surface 20 can extend between the leading edge 16 and the trailing edge 18, which follows an initial upstream upwardly sloping top or upper surface 20a starting at and extending downstream from the leading edge 16. The wing 14 and the wing portion 15 can have a lower or bottom surface 21 extending between the leading 16 and trailing 18 edges. This can result in an airfoil cross section, design or shape, as known in the art. At least one air bypass, diverting or redirecting passageway, conduit, plenum, hole opening, tube or vent 22 can extend through the wing portion 15 from the upstream leading edge 16 to a downstream rear location on the downwardly sloping upper surface 20 of the wing portion 15, and can be straight as well as generally longitudinally in alignment with the general direction of travel 9 of the aircraft 10 along a longitudinal axis X. The at least one passageway 22 can have at least one corresponding inlet 22a at the leading edge 16, and at least one corresponding exit location or outlet 22b that can extend through the upper surface 20 partway about halfway or just beyond halfway between the leading edge 16 and the trailing edge 18 on the downwardly sloping portion of upper surface 20. The at least one outlet 22b can be located upstream of a downstream flap 28 of the wing 14. When the at least one passageway 22 is open, air can enter the inlet 22a, and the outlet 22b can direct air 8 passing through passageway 22 over the downstream flap 28.

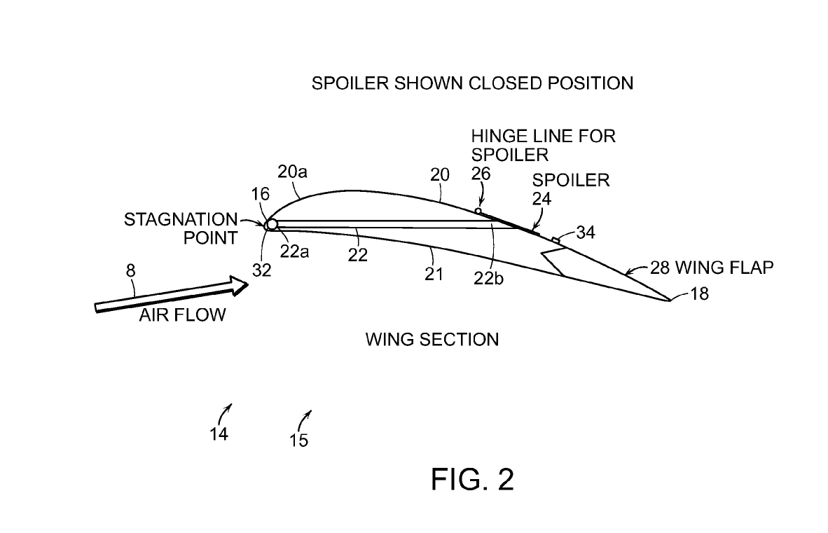

At least one spoiler or air flow control, directing or diverting member 24 can be moveably, rotatably or pivotably mounted to a rear or downstream downwardly sloping location of the upper surface 20, such as along or by a lateral hinge line or hinge 26 upstream of the at least one outlet 22b. The at least one spoiler 24 can include at least one generally flat plate, panel or baffle, and selectively movably cover or close and uncover or open the at least one outlet 22b of the at least one passageway 22, as indicated in FIG. 2 where the at least one spoiler 24 covers the at least one outlet 22b, and FIG. 3 where the at least one spoiler 24 can be pivotably moved upwardly away from the at least one outlet 22b to uncover the at least one outlet 22b, allowing the passage of air 8 through the at least one passageway 22. The at least one spoiler 24 can be flat or have a slight curvature, to closely lie on or against the upper surface 20. In some embodiments, the at least one spoiler 24 can be moved by a sliding mechanism to slidably cover or uncover the at least one outlet 22b. A single spoiler 24 can cover or uncover a single outlet 22b, or multiple outlets 22b, depending upon the situation at hand. In some embodiments the at least one spoiler 24 at the at least one outlet 22b can act as or similar to a valve, or can be replaced with suitable valves.

The at least one spoiler 24 can be operated by an actuator 30, which can be manually operated, or electronically operated, such as with a servo motor, hydraulically or pneumatically operated via a control line 38 and controller 40. In some embodiments, the controller 40 can be or include a computer or electronics. At least two skin friction meters 34 can be located downstream from the at least one outlet 22b to verify the status of a boundary layer and can be electrically connected to controller 40 by lines 36. The controller 40 can be electrically connected to an accelerometer 42 which can provide input regarding upward acceleration or movement of the aircraft 10 to controller 40, for automatically operating actuator 30 and the at least one spoiler 24. If desired, the at least one passageway 22 can have at least one valve or inlet flow control member 32 at the inlet 22a, which can be connected to and controlled by controller 40. Each wing portion 15 can be similar and similarly connected.

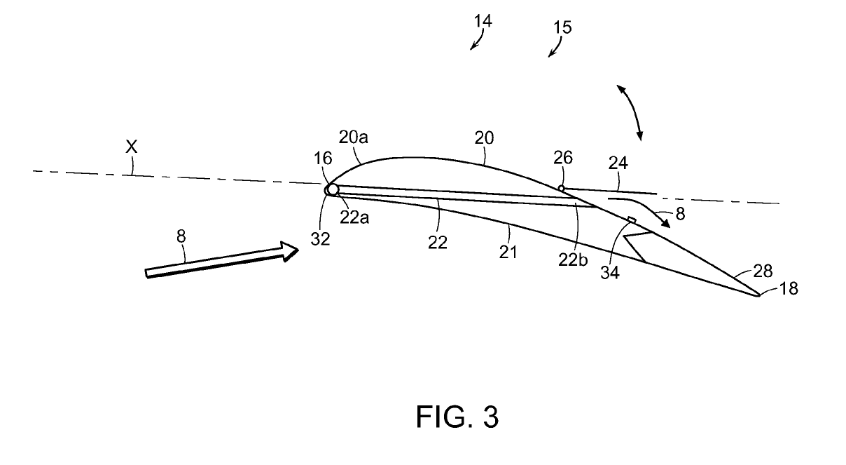

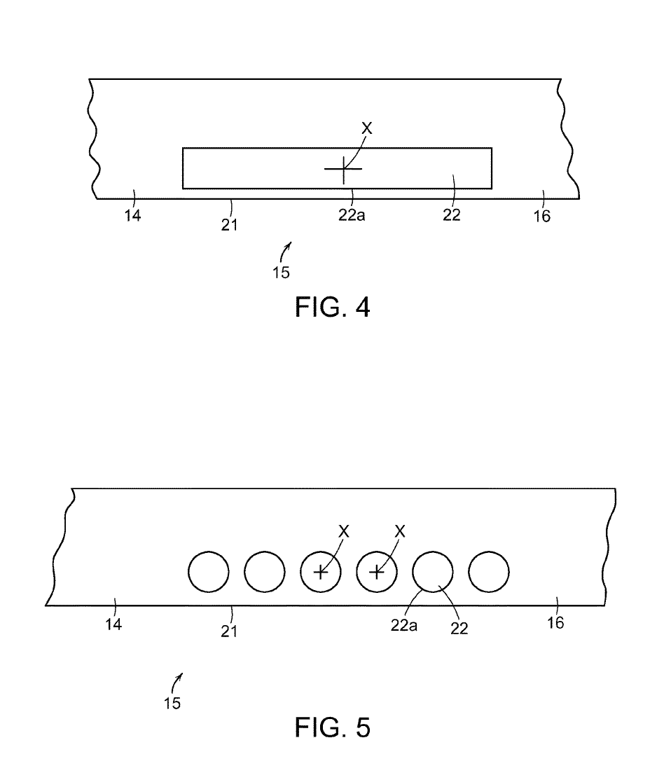

In some embodiments of the present invention, referring to FIG. 4, the at least one passageway 22 can be a single passageway or plenum having a high pressure inlet 22a at the leading edge 16 of the wing 14, and a low pressure outlet or exit location 22b at a downstream location. In other embodiments, referring to FIG. 5, the at least one passageway 22 can include multiple passageways 22, plenums or tubes having respective inlets 22a, and outlets 22b that can be aligned or positioned laterally side by side along an axis parallel to hinge line 26. Cross sectional shapes of the at least one passageway 22 can be rectangular, round, oval, or a combination of curves and/or straight sections. The at least one passageway 22 can include a manual or automatic valve 32 at the inlet 22a, which can be manually or automatically operated by controller 40. The low pressure outlet or exit location 22b of the at least one passageway 22 can be upstream from and aimed at a downstream flap 28 of the wing 14 that deflects air 8 jets therefrom so as to provide high lift force on the flap 28. This can be self-powered by the stagnation pressure at the leading edge 16 of the wing 14 and not by engine pressure. In the present invention, features of the gust alleviating wing portion 15 can be used on other aerodynamic members, or other structures on an aircraft including vertical and horizontal stabilizers. For example, the present invention can also include a gust alleviating vertical stabilizer as the aerodynamic member, which can include at least some of the features described herein for controlling lateral gusts moving across the center or symmetry line of an aircraft.

The present invention gust alleviating system 7 can be used on small or large aircraft, cargo aircraft, military as well as commercial aircraft. It can be installed on both new and existing aircraft. The present invention system 7 in one embodiment, can make direct use of the stagnation pressure at the leading edge 16 of the wing 14, carrying this pressure through, for example, several tubes 22 back to several points along the wing 14 that form a line of lateral outlets 22b in front of the flap 28 joint, but underneath a spoiler 24 whose hinge 26 runs parallel to the above line. In cruise flight there is usually no need to use system 7. It is usually only during air turbulence that system 7 goes into action. This could occur in other flight regimes, such as landing, take-off, when flaps 28 would be extended. The spoilers 24 can be limited to a small fraction of the wing 14 span. This section can be called the GAP, or Gust Alleviator Panel which can be only a few feet wide. The wing portion 15 can dump most of the lift in this portion 15 of the wing 14. There can be two such portions, one on the right wing 14R and one on the left wing 14L.

Depending on the size of the aircraft 10, the system 7 may be manual or servo driven. It may use acceleration feedback from accelerometer 42 as a part of the signal for action. The corrective action can be triggered by vertical acceleration that causes downward pressure on the seat. This is an indication that the wind gust or air turbulence has already increased the wing 14 lift upwards. The amount of this increase is directly proportional to the vertical component of the turbulent gust velocity. An upward gust can produce an increase in the angle of attack which can increase the lift instantly. How long it will continue that way can depend on the “scale of the turbulence”. This can be a number which can be in the range of 1,000 feet. If the aircraft 10 is moving at 500 feet per second, it can take two seconds for the aircraft 10 to travel that distance.

If the aircraft 10 is a large commercial jet in cruise mode, it can take longer for it to move. Such movement is known as the “short period mode” and the period of this movement for a large aircraft 10 can be from five to fifteen seconds. Thus, there is plenty of time for a well-trained pilot to handle the gust alleviating system 7 by just moving controls leading to the spoilers 24. The spoilers 24 can be simple flat plates that have a hinge line running parallel to the covered line of passageways 22 coming from the stagnation point at the leading edge 16 of the at least one wing 14.

In operation, during a wind gust or air turbulence, the pilot or controller 40 can manually or automatically open the at least one passageway 22, on the wings 14L and 14R. After the spoilers 24 open, the at least one passageway 22 on the parallel line can be exposed to the low static pressure at the rear of the wing 14. This can create a suction in combination with the high stagnation pressure at the leading edge 16, and the air 8 directed at wing portion 15, can have a portion that now-instead of following a lift creating curved path over the top of the wing 14 over the upwardly sloping top surface 20a starting at the leading edge 16, flows through the at least one passageway 22 through the wing 14 and wing portion 15 creating a jet of air 8 at the rear or outlet 22b. This exit jet of air 8 can be about 20 degrees below the tangent surface of the wing 14 at that point. This can insure that this high energy jet of air 8 can preserve the boundary layer at that point on the wing 14 and for some distance downstream.

This can retain lift over that rear wing position and flap 28, the diversion of the stagnation pressure to feed the resulting jet of air 8 can also cause the lift over the wing portion 15 to decrease significantly. This can counteract the uplift caused by the gust of wind or air turbulence. In addition, the upward position of the spoiler 24 can act as a fence to further passage of air aft. In other words, the wing portions 15 from the leading edge 16 to the spoiler 24 can be considered “stalled”.

As a result, by allowing air 8 to flow in a bypass or diversion through the at least one passageway 22 in the wing portions 15 of wings 14L and 14R, instead of over the entire top surface of the wing portions 15, the upward lift over the narrow or short length L₁ of the wing portions 15 relative the total length L of wings 14L and 14R can be reduced enough to compensate or alleviate the upward lift from a wind gust of air turbulence. In addition, control of the flaps 28 on the wings 14 and/or elevators on horizontal stabilizer at the tail can also be used in conjunction with the wing portions 15, for compensation. The at least one spoiler 24 can be controlled to selectively cover and uncover selected patterns or portions of the at least one passageway 22, to obtain different and/or desired lift characteristics. The location of the wing portions 15 on the wings relative to the fuselage 12 and wing tip 14a can be selected to also provide desired compensation characteristics.

In smaller aircraft the period of the “short period mode” can be much smaller and might not be handled by the pilot, but by controller 40 and servos fed by negative feedback. The system 7 may also include gust alleviation for horizontal gusts which can involve wing portion 15 devices on the rudder and a scheme to operate the wing portion 15 panels 24 out of phase. In addition, there can be at least two skin friction meters 34 behind the jet of air 8 exits to verify the status of the boundary layer there. This can apply to the straight, horizontal or longitudinal mode.

While this invention has been particularly shown and described with references to example embodiments thereof, it will be understood by those skilled in the art that various changes in form and details may be made therein without departing from the scope of the invention encompassed by the appended claims. For example, various features described or shown can be omitted or considered together. In addition, more than one wing portion 15 can be on a single wing 14 if desired. Although the passageways 22 typically extend straight along a longitudinal axis X, in some embodiments, the passageways 22 can have curves or can be curved. For example, the passageways 22 can have a slight downward curve to provide a downward force on the wing 14 by air 8 diverted therethrough.

What is claimed is:

1. A gust alleviating aircraft wing comprising:
a gust alleviating wing portion on the wing having a leading edge, a trailing edge, and a downwardly sloping upper surface therebetween, at least one passageway extending through the wing portion from the leading edge to a rear location on the downwardly sloping upper surface of the wing portion; and
at least one spoiler on the upper surface of the wing portion at the rear location for selectively movably covering and uncovering an exit location of the at least one passageway, whereby opening the at least one passageway is capable of diverting air flow through the at least one passageway and the wing portion for counteracting upward lift caused by a gust of wind.

2. The wing of claim 1 in which the wing portion is a segment of at least one wing.

3. The wing of claim 2 in which the gust alleviating wing portion is a left wing portion on a left wing, and the gust alleviating aircraft wing further comprising a gust alleviating right wing portion on a right wing.

4. The wing of claim 1 in which the at least one spoiler is pivotably mounted to the upper surface of the wing portion along a hinge upstream from the exit location of the at least one passageway.

5. The wing of claim 4 in which the at least one spoiler is at least one of manually and automatically operated.

6. The wing of claim 4 in which the at least one spoiler comprises at least one pivoting plate.

7. The wing of claim 1 in which the exit location of the at least one passageway is upstream of a downstream flap of the wing, for directing air exiting the at least one passageway over the downstream flap.

8. The wing of claim 1, further comprising at least one valve at an inlet location of the at least one passageway, for opening and closing the inlet location of the at least one passageway.

9. The wing of claim 1, in which the gust of wind comprises air turbulence.

10. A gust alleviating aircraft wing portion comprising:
a leading edge, a trailing edge, and a downwardly sloping upper surface therebetween, at least one passageway extending through the wing portion from the leading edge to a rear location on the downwardly sloping upper surface of the wing portion; and
at least one spoiler on the upper surface of the wing portion at the rear location for selectively movably covering and uncovering an exit location of the at least one passageway, whereby opening the at least one passageway is capable of diverting air flow through the at least one passageway and the wing portion for counteracting upward lift caused by a gust of wind.

11. A method of compensating for wind gusts with an aircraft wing comprising:
providing a gust alleviating wing portion on the wing having a leading edge, a trailing edge, and a downwardly sloping upper surface therebetween, at least one passageway extending through the wing portion from the leading edge to a rear location on the downwardly sloping upper surface of the wing portion; and
selectively uncovering an exit location of the at least one passageway with at least one selectively movable spoiler on the upper surface of the wing portion at the rear location, thereby opening the at least one passageway and diverting air flow through the at least one passageway and the wing portion for counteracting upward lift caused by the wind gusts.

12. The method of claim 11 further comprising providing the wing portion as a segment of at least one wing.

13. The method of claim 12 in which the gust alleviating wing portion is a left wing portion on a left wing, and the method further comprising providing the gust alleviating aircraft wing with a gust alleviating right wing portion on a right wing.

14. The method of claim 11 further comprising pivotably mounting the at least one spoiler to the upper surface of the wing portion along a hinge upstream from the exit location of the at least one passageway.

15. The method of claim 14 further comprising operating the at least one spoiler by at least one of manual and automatic operation.

16. The method of claim 14 further comprising providing the at least one spoiler with at least one pivoting plate.

17. The method of claim 11 further comprising:
positioning the exit location of the at least one passageway upstream of a downstream flap of the wing; and
directing air exiting the at least one passageway over the downstream flap.

18. The method of claim 11 further comprising opening and closing the inlet location of the at least one passageway with at least one valve at the inlet location of the at least one passageway.

19. The method of claim 11 further comprising compensating for wind gusts comprising air turbulence.
